(19) United States
(12) Patent Application Publication
(10) Pub. No.: US 2022/0064407 A1
(43) Pub. Date: Mar. 3, 2022

(54) CARBON FIBRE

(71) Applicant: The University of Newcastle, Callaghan, NSW (AU)

(72) Inventors: Rohan Stanger, Callaghan, NSW (AU); John Lucas, Callaghan, NSW (AU); Terry Wall, Callaghan, NSW (AU)

(21) Appl. No.: 16/768,467

(22) PCT Filed: Nov. 29, 2018
(86) PCT No.: PCT/AU2018/000240

§ 371 Date: May 29, 2020

(30) Foreign Application Priority Data
Dec. 1, 2017 (AU) 2017904856

(51) Int. Cl. C08K 7/06; C08J 5/24; C01B 32/05; D01F 9/12; D01D 5/08

(52) U.S. Cl. CPC C08K 7/06; C08J 5/243; C01B 32/05; C08K 2201/003; D01D 5/08; C01P 2002/88; C01P 2004/03; D01F 9/12

(57) ABSTRACT

The invention relates to a process for producing a fibre. The process comprises providing particulate coal, exposing it to a temperature sufficient for plasticisation thereof so as to form metaplastic coal, applying sufficient pressure to the metaplastic coal to extrude it through an orifice and allowing the extruded coal to solidify in the form of a fibre.

### FIELD

This invention relates to carbon fibres and to a process for making them

### BACKGROUND

Coal has the potential to add value to a range of emerging industries, particularly as thermal coal becomes increasingly displaced by renewable energy generation. A specific example is in the use of coal tars as chemical feed stocks and specialty carbon products which are abundant in polycyclic aromatic structures not found in substantial quantities elsewhere. Recent work with liquefaction residues has shown that they also may be refined from solvent extraction and used to manufacture carbon fibre. Importantly, it was found that different solvents produced extracts in different molecular weight ranges, which then required specific treatments (such as additional heat treatment or oxidation) to produce “spinnable” carbon fibres.

Carbon fibre is a unique material which exhibits high tensile strength, high chemical resistance, high temperature tolerance, low weight and low thermal expansion. These properties make it an excellent construction material for transport vehicles. The goal of replacing steel and aluminium with carbon fibre reinforced plastic composites is to significantly reduce vehicle weight without compromising strength. This material change is expected to lead to markedly reduced fuel use and consequently reduced CO2 emissions. The market for carbon fibre has been estimated to grow from US$1.9B in 2013 to US$3.7B in 2020 and has been steadily increasing since 2005 when Boeing adopted its use in aircraft manufacture. However a widely held view is that the current cost of production is prohibitively high, preventing significant market penetration. Current costs of carbon fibre vary widely but have recently been estimated to be around US$16/lb, while adoption into the automotive industry would require around US$4/lb. One of the key barriers to reducing the cost of carbon fibres is the use of polyacrilonitrile (PAN) as a precursor, which accounts for approximately 51% of the cost of manufacture. The energy requirement for manufacturing carbon fibre from PAN is also significantly higher than that of steel manufacture.

Acrylonitrile is produced from propene through a series of reactions, while pitch is typically sourced from petroleum distillation residue. In both cases the feed stock material is based on crude oil. While there is some pitch that is derived from coal, this material is linked to coke ovens and steel manufacture. In all cases, the precursor material is a product (or by-product) of a number of commercial processes and this adds to either the cost (in the case of PAN) or structural diversity (in the case of pitch) of the feed stock. Importantly, it also places a significant limit on the ability to scale operations for the expanding global demand of carbon fibres. While there are some efforts to manufacture carbon fibres from other sources (e.g. lignin, anthracene oil), these other precursor options will also require a number of pre-processing operations and are realistically many years from commercial operations.

There is therefore a need for a route to carbon fibre that is lower cost than synthesis from PAN.

### SUMMARY OF INVENTION

In a first aspect of the invention there is provided a process for producing a fibre comprising providing particulate coal; exposing the coal to a temperature sufficient for plasticisation of the coal so as to form metaplastic coal; applying sufficient pressure to the metaplastic coal to extrude it through an orifice; and allowing the extruded coal to solidify in the form of a fibre. Those skilled in the art may refer to the metaplastic coal as “metaplast” or “plastic layer”.

The following options may be used in conjunction with the first aspect, either individually or in any suitable combination.

The particulate coal may have a maximum particle diameter of less than about 1 mm, or of less than about 0.5 mm. The step of providing the particulate coal may comprise crushing and/or milling coal. It may additionally comprise removing from the crushed and/or milled coal any particles above about 1 mm, or above about 0.5 mm.

The particulate coal may be at least about 90% vitrinite, optionally at least about 95 or 98%. This may assist in reducing or minimising blocking of the orifice(s) by solid matter during extrusion. The process may comprise the step of purifying coal to a vitrinite concentration of at least about 90%, optionally at least about 95 or 98%. This percentage may be dependent on the characteristics of the raw coal and on the desired fibre qualities. The step of purifying may comprise grinding the coal to a particle size of less than about 50 microns, or of less than about 20 microns. It may then comprise at least partial separation of the vitrinite from inertinite and/or from mineral matter.

The temperature required for plasticisation of the coal to form metaplastic coal may be from about 350 to about 500° C. The pressure required for extrusion of the metaplastic coal may be from about 2 to about 5 MPa.

The orifice may have a diameter from about 0.5 to about 2 mm.

The metaplastic coal may have a viscosity during extrusion of from about 300 to about 100,000 Pa·s.

The step of allowing the extruded coal to solidify may comprise cooling the extruded coal to a temperature at which it solidifies.

The process may additionally comprise the step of drawing the extruded coal prior to allowing it to solidify. The draw ratio may be from about 100 to about 1,000,000. The drawing may be to a fibre diameter of about 5 to about 10 microns.

In an embodiment there is provided a process for producing a fibre comprising providing particulate coal having a maximum particle diameter of 0.5 mm; exposing the coal to a temperature of from about 350 to about 500° C., sufficient for plasticisation of the coal; applying a pressure of from about 2 to about 5 MPa to the metaplastic coal to extrude it through an orifice of diameter about 0.5 to about 2 mm diameter; and allowing the extruded coal to solidify in the form of a fibre.

In another embodiment there is provided a process for producing a fibre comprising providing particulate coal having a maximum particle diameter of 0.5 mm and a vitrinite content of at least about 90%; exposing the coal to a temperature of from about 350 to about 500° C., sufficient for plasticisation of the coal so as to form metaplastic coal; applying a pressure of from about 2 to about 5 MPa to the metaplastic coal to extrude it through an orifice of diameter about 0.5 to about 2 mm diameter; and allowing the extruded coal to solidify in the form of a fibre.

In a further embodiment there is provided a process for producing a fibre comprising providing particulate coal having a maximum particle diameter of 0.5 mm and a vitrinite content of at least about 90%; exposing the coal to a temperature of from about 350 to about 500° C., sufficient for plasticisation of the coal; applying a pressure of from about 2 to about 5 MPa to the metaplastic coal to extrude it through an orifice of diameter about 0.5 to about 2 mm diameter; drawing the extruded coal to a fibre diameter of about 5 to about 10 microns; and allowing the extruded coal to solidify in the form of a fibre.

In a second aspect of the invention there is provided a fibre having a mass ratio of carbon to hydrogen of greater than 12:1. It may have a porosity of at least about 25%.

The fibre may have a diameter of about 5 to about 1000 microns. It may not be produced from an acrylonitrile polymer.

The fibre of the second aspect may be made by the process of the first aspect. The process of the first aspect may produce a fibre according to the second aspect.

In a third aspect of the invention there is provided use of a fibre according to the second aspect, or of a fibre made by the process of the first aspect, as a filler for a composite, optionally a polymer composite.

### BRIEF DESCRIPTION OF DRAWINGS

FIG. 1: a scheme showing conceptual pathways for a carbon fibre process based on coal macerals. The direct approach is favoured for high purity vitrinite concentrates due to the inherent thermoplastic properties. Low vitrinite concentrates containing inertinite and mineral matter are considered to be of value for producing extractable material and volatile tar compounds that could be used as additives to control thermoplasticity.

FIG. 2: a photograph of an extrusion apparatus for evaluating coal behaviour (left); consisting of a linear actuator with displacement feedback, piston ram and extruder body and external heating system. Software is used to control extrusion force and speed. A digital microscope was used to record and assess general extrusion behaviour. On right: a diagram (upper) of the internal sections of the extruder body showing the step and an image (lower) of a laser cut circular plate with a 500 μm micro-drilled hole.

FIG. 3: graph showing measurement of extrusion speed using orifice plates of different size holes. Heating conditions of 5° C./min from 350 to 450° C. were used under a constant force of 25 kg. Coal softening began at 400° C. with extrusion occurring at 410° C. Estimated viscosity is indicated based on the measured velocity of the fluid and controlled force of the ram.

FIG. 4: Extrusion images at beginning of process (top) and at end (bottom) showing relative difference in volatile release. Early depolymerisation close to softening typically has low volatile evolution, while the development of fluid properties is often accompanied by higher tar and light gas production.

FIG. 5: A photograph showing that an intermediate extruded carbon product has sufficient flexibility at about 0.5 mmΦ to enable coiling and light handling. Overall flexibility is may be increased following further spinning (to smaller diameter) and higher temperature annealing.

FIG. 6: Graph showing the impact of heating rate on extrusion profiles using a 25 kg force. The softening profiles show that similarities between 3 and 5° C./min but slower heating rates shift the behaviour to lower temperatures. The extrusion point for the 0.5° C./min does not appear to fit the trend, but occurs later than the 1° C./min.

FIG. 7: Graph showing the effect of holding time on extrusion speed at selected temperatures of 400 and 405° C. using a force of 25 kg and a heating rate of 5° C./min.

FIG. 8: Graph showing the impact of time on step-wise extrusion operation at 390° C. with 5 minute intervals and a 2.5 mm displacement interval.

FIG. 9: Thermogravimetric analysis (TGA) of the raw coal compared to the extruded fibre product produce at different heating rates through the 0.5 mm orifice plate. All TGA runs used a heating rate of 5° C./min to 950° C. followed by a burn-off to obtain the sample ash.

FIG. 10: Photographs showing comparison of extruded products from the 0.5 mm orifice plate (left) and 2 mm orifice plate (right). Both were produced during a constant heating rate of 5° C./min.

FIG. 11: Photograph showing fibres produced at 5° C./min extruded through the 0.5 mm orifice plate. (Top): typical fibres produced in a run; (bottom): fibre tangle produced from minor blockage or when fibres stick to the walls and build-up.

FIG. 12: Photograph of fibres produced at 0.5° C./min extruded through the 0.5 mm orifice plate. The “sharkskin” appearance is well known in polymer extrusion as a phenomenon associated with mis-matched viscosity to extrusion dies. In this case, the viscosity is insufficiently low for the shear rate.

FIG. 13: Scanning electron micrograph (SEM) image of a cross-section of extruded fibre produced at 5° C./min constant heating rate showing the internal porosity of the material.

FIG. 14: SEM image taken of the length of extruded fibre produced at 5° C./min at constant heating rate. This shows that the fibre surface texture is still far from smooth.

FIG. 15: SEM image of mineral impurities in the extruded fibre. The image on the left shows distributed mineral impurities all below about 2 μm, while the right image shows a single mineral impurity around 20 μm in size.

FIG. 16: Scanning electron micrograph—energy dispersive x-ray spectroscopy (SEM-EDS) image taken of the mineral impurity from the right in FIG. 15. Indicating a high concentration of Fe and S and a distributed concentration of much smaller Al—Si mineral features below about 1 μm.

FIG. 17: convective modelling of fibre extrusion without (left) and with (right) a sheath surrounding the aperture.

FIG. 18: images of fibres extruded at different temperatures. The scale at the bottom of this figure is in centimetres.

FIG. 19: graph showing the impact of holding temperature on the displacement of the high fluidity coking coal. The marked points show where the coal has reached its steady state holding temperature either before observed extrusion (380° C.) or at the point of extrusion (400° C.).

FIG. 20: molecular weight profiles (LDI-TOF-MS) of feed coal (bottom), coal extruded under a ramped temperature profile (centre) and coal extruded at constant 400° C. temperature (top).

FIG. 21: molecular weight difference profiles of coal extruded under a ramped temperature profile (top) and coal extruded at constant 400° C. temperature (bottom), showing differences from the feed coal.

FIG. 22: pore size distribution obtained by image analysis for both ramped temperature and isothermally extruded fibres.

FIG. 23: photograph of extruded coal fibre heated post-extrusion to 875° C.

### DESCRIPTION OF EMBODIMENTS

An important aspect of using coal for making carbon fibres is its behaviour inside a higher pressure extrusion unit and the need to characterise its rheology. The inventors have evaluated the thermoplastic development needed for extrusion of a single coking coal in terms of heating rate and residence time and characterised the extruded fibre product. It was observed that the coal underwent a preliminary softening phase prior to extruding at significant speed. This phase appeared necessary to develop the critical viscosity for extrusion, and was affected by heating rate. The size of the orifice that the coal was extruded through also impacted the point of extrusion, with the smaller 0.5 mm hole requiring lower viscosity to be developed in order to flow at steady state. Other operating modes were developed to examine the coals thermoplastic properties over extended residence time and it was found that the coal could be maintained up to 60 minutes at selected temperatures. The product fibre was larger than commercial size, appearing slightly larger than the orifice size. Internal porosity and surface roughness were observed as coal-based fibre qualities in need of controlling as was mineral content and size.

Broadly, the present invention relates to a process for producing a fibre, most commonly a carbon fibre, by plasticising the coal using heat and applying pressure so as to extrude the metaplastic coal through an orifice. The extruded coal is then allowed to solidify into a fibre.

In the context of the present invention, a carbon fibre may be considered to be a fibre in which the carbon content is at least about 90% by weight. It may be at least about 95, 96, 97, 98, 99 or 99.5% and may in some instances be about 100%. The non-carbon content may be covalently bonded to the carbon (e.g. there may be some hydrocarbon content) or it may be physically entrained (e.g. there may be some metal or metal oxide or other mineral entrained in the carbon). The term “plasticisation” refers to conversion of a solid coal material into a form in which it is extrudable. This form may be a liquid, i.e. it may be a flowable material. Alternatively it may be in the form of a gel, in which the material does not flow until a threshold pressure is applied. This extrudable form is referred to herein as a “metaplastic” form. It will be understood that this does not preclude the presence of solid particles within the metaplastic material provided that there is a metaplastic (i.e. extrudable) matrix in which the solid particles are dispersed.

Coal generally contains extended covalently bonded carbon networks. It is therefore thought that in order to liquefy it, some degree of depolymerisation and/or bond breaking is necessary. However it is also thought that at the same temperature, over time some degree of crosslinking will also occur, leading to an increase in viscosity and ultimately solidification. Therefore the metaplastic form—extrusion—solidification of the present invention may be viewed as a dynamic process which is time sensitive. The time for the extrusion will be a function of the temperature, since this will affect viscosity, and of pressure, since this will affect extrusion rate. It should also be noted that at the elevated temperature used for plasticisation of the coal, low molecular weight species may be produced. At least some of these may be sufficiently low as to be volatile at atmospheric pressure. However at the pressures used in the extrusion, these are generally retained within the metaplastic coal during the extrusion process. They can therefore further plasticise the coal and reduce its viscosity. Following extrusion, and consequent reduction of pressure, these low molecular weight species can give rise to porosity in the resulting fibre.

The coal used in the present invention commonly has a maximum particle diameter of about 1 mm or less. It may have a maximum particle diameter of less than about 1, 0.5, 0.4, 0.3, 0.2, 0.1, 0.05, 0.02 or 0.01 mm. It may have a mean particle diameter (number average or weight average) of less than about 1 mm, or less than about 0.75, 0.5, 0.4, 0.3, 0.2, 0.1, 0.05, 0.02 or 0.01 mm. The process may therefore include a step of crushing and/or milling the coal to a desired particle diameter. It may also comprise removing particles above a desired upper particle size limit. This may be for example by means of sieving or by some other suitable method. The coal used as a feed material in the present invention may have a mass-to-charge distribution between about 500 and about 5000 as measured by LDI-TOF-MS. The peak mass-to-charge ratio may be between about 1500 to about 2500, or about 1500 to 2000 or about 2000 to 2500, e.g. about 1500, 2000 or 2500.

Coal generally contains varying amounts of vitrinite and inertinite. Vitrinite represents the plasticisable portion of the coal whereas inertinite represents non-plasticisable matter. Therefore it is preferable to have as high as possible proportion of vitrinite. This may be achieved by selecting a suitable grade of coal with high vitrinite content. Typically Australian coking coals are from about 50 to about 80% vitrinite. Alternatively or additionally the vitrinite content may be increased by removing at least some of the non-vitrinite matter from the coal. Commonly this separation may be achieved by means of a fluid of suitable density. Thus the coal is initially crushed to a particle size of around 20 microns or less. At this size, very few particles contain both vitrinite and inertinite and most particles are either vitrinite or inertinite. The coal may be crushed to a particle size of less than or equal to about 50 microns, or less than or equal to 40, 30, 20, 15 or 10 microns. Vitrinite has a specific gravity of around 1.25 to around 1.28 whereas inertinite has a specific gravity of around 1.3 to 1.35. Therefore separation of the ground coal in a fluid of specific gravity between about 1.25 and about 1.3 will result in the vitrinite floating and the inertinite sinking. This separation may be accelerated by suitable centrifugation. Centrifugation may be sufficient to apply a force of at least 2G, or at least 3, 4, 5, 10, 20, 50 or 100G. It will be readily understood that a fluid of suitable specific gravity will be readily preparable by mixing of a high specific gravity fluid with a low specific gravity fluid in a suitable ratio. In this context “high” and “low” are defined relative to the desired specific gravity. An alternative to density separation for concentrating the vitrinite is the use of froth flotation, in which the vitrinite dominant particles are adhered to air bubbles and removed from a slurry of vitrinite and inertinite. The vitrinite concentrate is lifted in the froth to the overflow, while the inertinite particles remain the in slurry. The coal may be purified to a vitrinite content of at least about 90%, or at least about 95, 96, 97, 98 or 99% on a w/w basis.

Plasticisation of the coal may be achieved by use of a suitable temperature. If the temperature is below about 350° C., the coal may not become plastic, or may have sufficiently high viscosity that the extrusion rate will be impracticably low. Above about 500° C. the viscosity may be unsuitably low and there may be an undesirably high level of gases produced. Therefore a temperature range of about 350 to about 500° C. represents a suitable tradeoff between cross-linking rate, depolymerisation rate, gas production rate and viscosity. The temperature may be from about 350 to 400, 400 to 450, 450 to 500, 350 to 450 or 400 to 500° C. The temperature may be kept constant during the extrusion or it may be increased either stepwise or continuously. The rate of increase may be from about 0.5 to about 10° C./minute, or from about 0.5 to 5, 0.5 to 2, 0.5 to 1, 1 to 10, 2 to 10, 5 to 10, 1 to 5, 2 to 5 or 1 to 2° C./minute, e.g. about 0.5, 1, 1.5, 2, 2.5, 3, 3.5, 4, 4.5, 5, 6, 7, 8, 9 or 10° C./minute. For example the temperature may be increased from about 350° C., optionally to a maximum of about 500° C., at a rate of from about 0.5 to about 10° C./minute. In some instances, the rate may be varied through the extrusion process, either continuously or stepwise.

The plasticisation of the coal may be facilitated by addition of liquid components. These may be liquid extracts from coal or may be some other liquid components. In this context, a liquid component is one that is liquid at temperatures from about 350 to about 500° C. This may be assessed either at the extrusion pressure or at 1 atmosphere pressure. The liquid component may be added at a ratio to the coal of between about 1:100 and about 1:5, or about 1:100 and about 1:20, e.g. about 1:100, 1:50, 1:20, 1:10 or 1:5. In some instances, no liquid components are added to the coal.

The extrusion may be conducted at sufficient pressure for extrusion through an orifice. The pressure may be constant or may be increased either stepwise or continuously throughout the extrusion. Commonly pressures will be within the range of about 2 to about 5 MPa, or about 2 to 4, 2 to 3, 3 to 4, 4 to 5 or 3 to 4 MPa, e.g. about 2, 2.5, 3, 3.5, 4, 4.5 or 5 MPa. In some instances the pressure may be considerably higher than this, e.g. up to about 60 MPa. Thus the pressure may be about 2 to 60, 5 to 60, 5 to 30, 5 to 10, 10 to 60, 20 to 60, 40 to 60, 10 to 50, 10 to 20 or 20 to 50 MPa, e.g. about 10, 15, 20, 25, 30, 35, 40, 45, 50, 55 or 60 MPa. The required pressure will depend on the viscosity of the metaplastic coal, which in turn will depend on the nature of the coal used in the process (e.g. its vitrinite content) and on the temperature. Suitable pressures may be determined in each case by routine experimentation.

Suitable conditions therefore, may be a temperature of 350° C., increasing at a rate of from 0.5 to 5° C./minute but not exceeding 500° C., under a constant pressure of about 2.2 MPa.

Extrusion is commonly through an orifice. The shape and size of the orifice will affect the shape and diameter of the extruded coal. Thus a circular orifice will result in an approximately circular cross-section of the extruded coal. The orifice may be circular, or may be oval or may be square or may be pentagonal or hexagonal or may be some other shape. It may have a diameter (or in the case of a non-circular orifice, a maximum or mean diameter) of about 0.5 to about 2 mm. This represents a compromise between obtaining acceptable rates of extrusion and obtaining suitably small diameter fibres. The diameter may be between about 0.5 and 1 or between 1 and 2 mm, e.g. about 0.5, 0.6, 0.7, 0.8, 0.9, 1, 1.1, 1.2, 1.3, 1.4, 1.5, 1.6, 1.7, 1.8, 1.9 or 2 mm. The orifice may have straight sides, i.e. the diameter may be constant along its length, or it may have tapered sides so that the diameter reduces towards the outer end. In this context the “outer” end is that end of the orifice from which the coal exits the orifice. Similarly, the “inner” end is that end at which the coal enters the orifice. The ratio of the diameter at the inner end of the orifice to that at the outer end may be from about 1 to about 5 (i.e. from about 1:1 to about 5:1), or about 1 to 3 or about 2 to 5, e.g. about 1, 1.5, 2, 2.5, 3, 3.5, 4, 4.5 or 5. In some instances extrusion may be through multiple orifices so as to extrude multiple fibres simultaneously. There may be for example between 1 and 100 orifices, or 1 to 50, 1 to 10, 1 to 5, 5 to 100, 10 to 100, 50 to 100 or 10 to 50 orifices. In some instances the orifice may be smaller than described above, e.g. between about 10 and 500 microns, or about 10 to 200, 10 to 100, 10 to 50, 10 to 20, 20 to 500, 100 to 500, 200 to 500, 50 to 200, 50 to 100 or 100 to 200 microns, e.g. about 10, 20, 30, 40, 50, 60, 70, 80, 90, 100, 150, 200, 250, 300, 350, 400, 450 or 500 microns. In this event there may be more orifices than described above, e.g. from about 100 to about 2000, or about 100 to 1000, 100 to 500, 100 to 200, 200 to 2000, 500 to 2000, 1000 to 2000, 200 to 1000 or 500 to 1000, e.g. about 100, 150, 200, 250, 300, 350, 400, 450, 500, 600, 700, 800, 900, 1000, 1100, 1200, 1300, 1400, 1500, 1600, 1700, 1800, 1900 or 2000 orifices. In the case of multiple orifices, the coal may be extruded through an orifice plate which comprises the orifices. The orifices may be distributed evenly in the orifice plate. They may be distributed equidistantly therein. They may be distributed randomly therein. They may be distributed in a regular pattern therein, e.g. a rectangular pattern, a hexagonal pattern, a rhomboidal pattern or some other pattern.

The orifice, or orifices, or orifice plate, may be fitted with a sheath or sleeve. This may serve to at least partially trap hot gases so as to control the cooling of the extruded material. Thus during extrusion, the extruded fibre may pass from the nozzle through the sheath or sleeve.

The extrusion may be conducted under an inert atmosphere. It may for example be conducted under nitrogen, argon, helium, carbon dioxide or some other inert atmosphere. It may be conducted under a non-oxidising atmosphere. Alternatively it may be conducted in air. As gases are commonly evolved during initial heating of the coal in order to plasticise it, these may serve to displace oxygen so as to reduce or minimise oxidation of the plasticised coal. The atmosphere defined above may pertain during heating of the coal so as to plasticise it, following plasticisation or following extrusion (i.e. the coal may be extruded into the atmosphere), or at any two or all of these times.

During the process described herein, commonly there will be an initial phase where no extrusion through the orifice occurs. This is thought to occur as the softening coal fills the vacant spaces that existed between the particles. Once these spaces are largely eliminated, the applied pressure can cause the metaplastic coal to extrude through the orifice(s). During the extrusion, the viscosity of the metaplastic coal maybe from about 300 to about 100000 Pa·s or between about 300 to 50000, 300 to 10000, 300 to 5000, 500 to 100000, 1000 to 100000, 5000 to 100000, 10000 to 100000, 10000 to 50000, 20000 to 50000, 1000 to 50000 or 1000 to 20000 Pa·s, e.g. about 300, 400, 500, 600, 700, 800, 900, 1000, 1200, 1400, 1600, 1800, 2000, 2500, 3000, 3500, 4000, 4500. 5000, 6000, 7000, 8000, 9000, 10000, 15000, 20000, 25000, 30000, 35000, 40000, 45000, 50000, 60000, 70000, 80000, 90000 or 100000 Pa·s. The viscosity may vary throughout the extrusion. This may be due in part to changes in temperature. It may be due in part to depolymerisation and/or cross-linking processes occurring within the coal. It may be in part due to the evolution of low molecular weight plasticising materials from the coal under the influence of high temperature. The extrusion pressure is related to required viscosity, with higher pressures needed to extrude higher viscosity metaplastic coal.

Once the metaplastic coal exits the orifice, it commonly swells slightly, resulting in a fibre diameter slightly greater than the orifice diameter. This phenomenon of die swell is well known and is thought to result from the viscoelastic properties of the extrudate. The die swell may be between about 0 and about 20%, depending on the pressure and the nature of the coal, or about 0 to 10, 0 to 5 or 0 to 2%.

For certain applications it is desirable to produce fibres of under 100 microns diameter. Due to the relatively high viscosity of the liquefied coal, it is generally not practicable to extrude through an orifice of this size as the extrusion rate would be very slow. In order to obtain such small diameters, a tensile force may be applied to the extruded coal prior to its solidification. This process may be similar to conventional pultrusion. It may be useful to maintain the extruded coal at a sufficient temperature to retain its fluid properties during application of the tensile force. The force may be sufficient to attain a fibre diameter of less than about 100 microns, or of less than about 75, 50, 25 or 10 microns, or of from about 1 to about 100 microns, or from about 1 to 50, 1 to 20, 1 to 10, 1 to 5, 5 to 100, 10 to 100, 20 to 100, 50 to 100, 5 to 50, 5 to 20, 10 to 50 or 20 to 50 microns, e.g. about 1, 2, 3, 4, 5, 6, 7, 8, 9, 10, 15, 20, 25, 30, 35, 40, 45, 50, 60, 70, 80, 90 or 100 microns. The pultrusion may be conducted while maintaining the fibre at a temperature of from about 200 to about 400° C., or from about 200 to 300, 300 to 400 or 250 to 350° C., e.g. about 200, 250, 300, 350 or 400° C. The force may be sufficient to obtain a draw ratio of from about 100 to about 1000000, or about 100 to 100000, 100 to 1000, 1000 to 1000000, 10000 to 100000 or 1000 to 100000, e.g. about 100, 500, 1000, 5000, 10000, 50000, 100000, 200000, 300000, 400000, 500000, 600000, 700000, 800000, 900000 or 1000000 or more. In this context the draw ratio represents the the ratio of the distances between two points along the length of the fibre before and after drawing. The above draw ratios correspond to a reduction in diameter of from about 10 to about 1000.

Once the desired fibre diameter is achieved, the fibre may be solidified. This may comprise cooling the fibre. The cooling may be to a temperature below about 250° C., or less than about 200, 150 or 100° C., or to a temperature of about 250, 200, 150, 100, 50 or 20° C. It may comprise cooling to ambient temperature. The plasticised coal has the ability to cross-link or resolidify and may not require oxidation or any oxidative conditions to facilitate this process. It should be noted that cross-linking of PAN-derived fibres and pitch fibres commonly requires oxidative conditions. This difference is significant because the oxidative step requires 02 to diffuse through the fibres. This diffusion is both slow (requiring long residence times and hence greater capital) and may influence the final fibre strength (for example causing radial stress if the diffusion rate is too high). The fact that the extruded coal described herein can solidify without oxidation provides the possibility of simpler processing. Following extrusion, either before or after the solidification step, the fibre may be annealed. The annealing may be conducted at a temperature of about 800 to about 1500° C., or about 1000 to 1500, 800 to 1200, 1000 to 1200, 1200 to 1500 or 1100 to 1300° C., e.g. about 800, 850, 900, 950, 1000, 1050, 1100, 1150, 1200, 1250, 1300, 1350, 1400, 1450 or 1500° C., or at times higher. This process commonly produces a highly cross-linked carbon structure of higher strength. Annealing conditions may be similar to those used for carbon fibres made from polyacrylonitrile. The annealing may be conducted in a non-oxidising atmosphere. It may be in an inert atmosphere. It may for example be conducted in nitrogen, or in argon, or in a mixture of non-oxidising or inert gases.

As the coal is heated prior to extrusion, some of the gases in the spaces between the particles may dissolve in the liquefied coal, or may be entrained therein. Additionally, thermal reactions within the coal may result in production of gaseous products in the coal. Once the metaplastic coal is extruded, the pressure will naturally drop. This pressure drop may result in dissolved gases coming out of solution and in any gas filled voids expanding. Consequently, the resulting fibre may have gas filled voids in its structure. These may represent less than about 50% of the volume of the fibre, or less than about 40, 30, 20 or 10%, or from about 10 to about 50%, or about 20 to 50, 25 to 50, 30 to 50, 10 to 40, 10 to 30, 10 to 20 or 20 to 30%, e.g. about 10, 15, 20, 25, 30, 35, 40, 45 or 50%. The void volume, or porosity, of the fibre may be at least about 20, 25, 30, 35, 40 or 45%. The voids within the fibre may have a mean diameter of around 1 to about 50 microns, or about 1 to 20, 1 to 10, 10 to 50, 20 to 50, 10 to 30 or 2 to 20 microns, e.g. about 1, 2, 3, 4, 5, 10, 15, 20, 25, 30, 35, 40, 45 or 50 microns. The mean diameter may be a number average diameter. The fibres may have a D50 pore size (i.e. median pore size) of between about 1 and about 30 microns, or between about 1 and 20, 1 and 10, 5 and 30, 10 and 30, 20 and 30, 5 and 20, 5 and 10 or 10 and 20 microns, e.g. about 1, 2, 3, 4, 5, 10, 15, 20, 25 or 30 microns. If the fibre is drawn, as described above, the lateral diameter of the voids may reduce correspondingly, whilst the length may increase correspondingly. In some instances it may be desirable to reduce or increase porosity for targeted fibre qualities. This may be achieved by a combination of heating conditions, extrusion parameters and/or die design.

The porosity of the fibres may be controlled by appropriate manipulation of the processing parameters. Thus particular porosity and pore sizes may be targeted based on the desired properties of the fibre. For example, for high strength it may be beneficial to reduce porosity. For other properties, such as density modification of a composite, it may be beneficial to have higher porosity. The porosity of the fibre may be controlled by selecting an appropriate extrusion temperature. Thus, for example, extrusion at lower temperatures, close to the plasticisation temperature (softening point) of the coal and higher pressures will provide a lower porosity and therefore higher strength fibre. Additionally or alternatively, a sintered filter may be used to allow controlled degassing in order to reduce the porosity. If higher porosity is targeted, higher temperatures and hence higher fluidity (lower viscosity) may be used. The pressure in this case may be used to control the size of the pores. Thus higher pressure would provide smaller pore sizes. It should be noted that the pore size should not approach the diameter of the fibre as this would result in substantial weakening of the fibre. As a general guideline, the maximum pore size should not be greater than about 20% of the fibre diameter, or not greater than about 10, 5, 2 or 1% thereof. This may be significant if small extrusion orifices are used.

Fibres made by the process described herein may have a diameter from about 5 to about 1000 microns. The diameter will, as discussed above, depend on the dimensions of the orifice through which the coal is extruded and on any subsequent drawing of the fibre prior to solidification. The diameter may be from about 5 to 500, 5 to 100, 5 to 50, 5 to 20, 5 to 10, 10 to 1000, 50 to 1000, 100 to 1000, 500 to 1000, 100 to 500, 100 to 200, 200 to 500, 10 to 20 or 20 to 50 microns, e.g. about 5, 6, 7, 8, 9, 10, 15, 20, 25, 30, 35, 40, 45, 50, 60, 70, 80, 90 100, 150, 200, 250, 300, 400, 450, 500, 600, 700, 800, 900 or 1000 microns. The fibre may be a carbon fibre. It may have a C:H ratio of at least about 12 (i.e. 12:1) on an elemental or mole basis, or at least about 15, 20, 50 or 100. The fibre may have a specific gravity of less than that of carbon fibre derived from polyacrylonitrile. It may have a specific gravity of about 0.7 to about 1, or about 0.7 to 0.9, 0.7 to 0.8, 0.8 to 1, 0.9 to 1 or 0.8 to 0.9, e.g. about 0.7, 0.75, 0.8, 0.85, 0.9, 0.95 or 1. If the fibre is annealed, which, as discussed elsewhere herein may be conducted at a temperature of between about 800 and about 1500° C., the fibre may be substantially pure carbon. It may be at least about 95% carbon on a molar basis, or at least about 96, 97, 98, 99, 99.5 or 99.9% carbon on a molar basis.

The fibres made by the above described process may be used as fillers in a polymer composite (the composite comprising a filler dispersed in a polymer matrix). Thus the invention encompasses a process for making a polymer composite comprising dispersing a fibre, or fibres, according to the invention, or made according to the invention, in a polymer matrix. The incorporation may be conducted under conditions in which the polymer matrix is liquid. The process may comprise dispersing the fibre(s) in a precursor to the polymer matrix, e.g. a prepolymer, and causing the precursor to polymerise. The polymer matrix may be an epoxy or a polyurethane or a polyolefin or a polyester or a polyamide or some other suitable matrix. The fibres may be present at a loading of from about 1 to about 20% by volume or weight, or from about 1 to 10, 1 to 5, 1 to 2, 2 to 20, 50 to 20, 10 to 20 2 to 10 or 2 to 5%, e.g. about 1, 2, 3, 4, 5, 6, 7, 8, 9, 10, 11, 12, 13, 14, 15, 16, 17, 18, 19 or 20%. The fibres may be cut before incorporating as a filler or they may be used as a continuous fibre or as a woven fibre product. If they are cut, they may have a mean length of from about 1 to about 100 mm, or about 1 to 50, 1 to 20, 1 to 10, 1 to 5, 5 to 100, 10 to 100, 50 to 100, 2 to 20, 2 to 10, or 5 to 10 mm, e.g. about 1, 2, 3, 4, 5, 120, 15, 20, 25, 30, 35, 40, 45, 50, 60, 70, 80, 90 or 100 mm. In some instances even shorter fibres may be used. The use of these fibres as fillers may serve to increase tensile strength, increase tensile modulus, increase bending modulus or improve some other property or combination of properties. This may be achieved at lower cost to conventionally produced carbon fibres.

The design of the orifice for extrusion of the fibres can affect the surface morphology of the fibres. In some instances the fibre may be quite smooth whereas in other instances the fibre may be rough. It is thought that the use of rough fibres may be beneficial in filler applications as the surface roughness may improve adhesion between the fibre and the matrix, leading to improved composite properties.

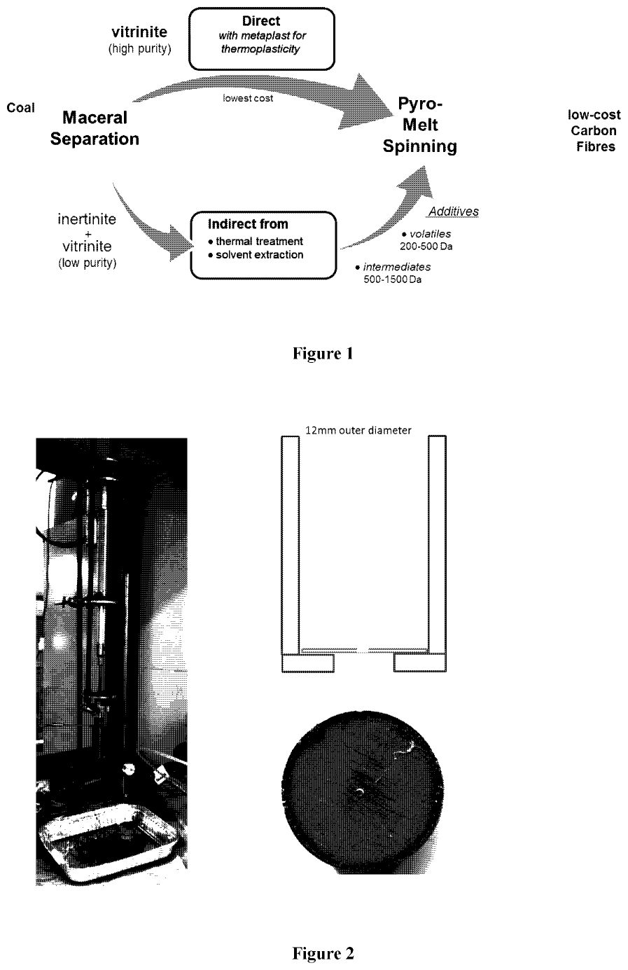

In summary, therefore, the present invention relates to the production of carbon fibres directly from coal, deliberately disrupting and controlling the pyrolysis process to exploit the coal's natural thermoplasticity during heating (FIG. 1). One option is to establish a direct coal-based carbon fibre production by highly concentrating the vitrinite component of the coal and feeding this concentrate into a melt spinning extrusion process optimised for this feed stock. Viscosity modification may be controlled via thermal profile and additives derived from pyrolysis. This process is comparatively simple, low cost and may be rapidly scaled to commercial output. An indirect approach would utilise the remaining “lower” quality vitrinite/inertinite material after separation by a combination of thermal treatment and solvent extraction to remove useable molecular material for use as novel precursors in traditional wet spinning and melt spinning methods for carbon fibre production.

### EXAMPLE

A novel and highly customisable apparatus was constructed to evaluate the extrusion behaviour of coal. FIG. 2 shows an image of the system containing a linear actuator (150 mm extension), piston ram and extrusion body and external heater. The linear actuator was controlled with a 5V signal from a Labjack U6 Pro data logging system with a 5V displacement signal used as feed-back. This provided a 40 μm resolution for motion with custom control software created using DAQFactory. The extruder force was controlled using a pulse-width-modulation (PWM) signal from the 12V power supply and could obtain a maximum force equivalent to 50 kg. The linear actuator could travel at a maximum speed of 840 mm/min. The extruder body was constructed from 1″ OD 304SS with 12 mm ID with matched ram dimensions and a length of 100 mm. The body was welded to a tri-clover sanitary clamp for easy removal from the piston. It was manufactured with a small step at its base to allow for circular plates with micro-drilled holes to be supported internally. In practice, 11.9 mm diameter plates were laser cut and then manually drilled with holes ranging from 2 mm down to 250 μm. These were used as required and could be punched out and disposed of if coked in. In practise, the 250 μm orifice did not allow adequate extrusion with the apparatus's force limit. This work will show results from the 2 mm and 500 μm orifice plates. The heater consisted of a coiled mineral insulated tubular heating element controlled with a eurotherm ON/OFF control unit and solidstate relay. Temperature was controlled using a built-in type J thermocouple located in the tip of the tubular heating element. Preliminary heating tests were undertaken to determine the temperature gradient between this external point and the centre using a packed bed of activated carbon. It was found that a fast ramp at 50° C./min to 350° C. followed by a 5 minute hold provided temperatures within 2° C. between external and central positions. A 5° C./min heating rate during extrusion produced a constant temperature difference of 9-10° C. between measurement positions. A small digital microscope was used as a means of assessing extrusion starting point and general behaviour.

This extrusion system was operated in a similar way as a capillary rheometer, where a liquid is forced through a narrow length of pipe to ascertain its viscosity. A critical difference between standard capillary rheometers is that a mechanical force (generated by the linear actuator) is used as a control instead of pressure. This is due to nature of the plastic transformation of coal, where force may be applied to a solid packed bed of coal particles, but pressure control (by way of gas pressure) would result in a high sweep gas. The viscosity was estimated using the pressure drop relationship with the Darcy friction factor (equations 1 and 2 below)

$$\begin{matrix}\frac{Δ P}{L} = {f}_{D} \frac{ρ}{2} \frac{{v}^{2}}{D} where {f}_{D} = \frac{64}{Re} & ( 1 ) \\ μ = \frac{{FD}_{orifice}^{2}}{8 π \overline{v} {LD}_{extruder}^{2}} & ( 2 )\end{matrix}$$

where ΔP is based on the controlled force from the linear actuator (F) and the cross-sectional area of the extruder (12 mm internal diameter); L is typically the length of pipe and in this case equal to the orifice plate thickness of 1 mm.

An inherent assumption in the use of this equation is that the flow through the orifice plate is fully developed and laminar. Since the coal is extruded through a thin orifice plate, it is unlikely to be fully developed, however for the purposes of estimation the errors are expected to be small compared to the changes in fluidity of the coal. Estimations of Reynolds number at the lowest viscosity (and highest flow) indicated that the flow is laminar. Overall, it can be observed that the flow equation can be reduced to an inverse relationship between viscosity (μ) and velocity of the fluid through the orifice (v̅). The flow through the orifice was calculated from the speed of the piston by accounting for differences in cross-sectional areas between extruder and orifice (equation 3).

$${\overline{v}}_{fluid} = {\overline{v}}_{piston} \frac{{D}_{extruder}^{2}}{{D}_{orifice}^{2}} \qquad ( 3 )$$

### Sample

The sample selected was an Australian coking coal from Queensland with coal quality details given in Table 1. A coking coal was targeted for this work because of the thermoplastic properties at low heating rates. The sample was initially crushed to a top size of 0.5 mm (the size of the orifice) to determine the issues associated with plugging. However, it was found in testing that test variation could be reduced with a lower particle top size. Apart from sizing, no other pre-treatment was conducted prior to testing. Each run used approximately 4 g of sample.

TABLE 1
Coal analysis

| Proximate Analysis | | | | | | | | Petrographic analysis | | |
|---|---|---|---|---|---|---|---|---|---|---|
| | | Volatile | Fixed | Ultimate Analysis | | | | Vitrinite | | |
| Moisture | Ash | Matter | Carbon | C | H | N | O | Reflectance | Vitrinite | Inertinite |
| (% ad) | (% ad) | (% ad) | (% ad) | (% daf) | (% daf) | (% daf) | (% daf) | Rᵥmax | % vol | % vol |
| 2.0 | 6.5 | 34.5 | 57.0 | 85.0 | 5.70 | 2.20 | 6.44 | 0.90 | 77.0 | 18.0 |

### Results

### Measurements of the Extrusion Process

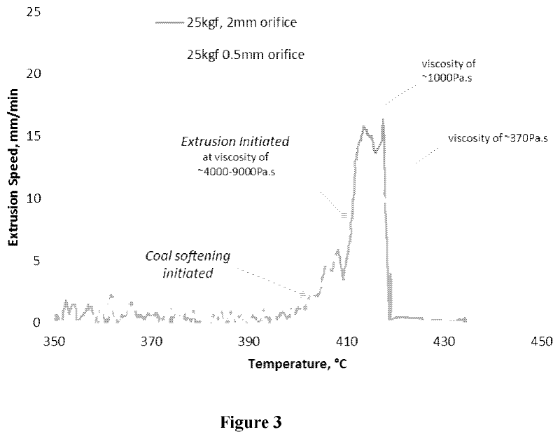

A typical heating test involved rapid heating to 350° C. and holding for 5 minutes to equilibrate the temperature before controlled heating to 450° C. Prior to heating, the piston force was set (to 25 kg force) and controlled to descend to “zero” displacement. This applied a force to the packed coal and allowed the impacts of heating to be measured as it descended. In practise, extrusion would begin after an initial softening period where the piston would slowly descend without any material exiting the orifice plate. When material was sighted with the microscope, the time and temperature was recorded. FIG. 3 shows a typical “speed” profile based on the linear measurements for 2 different orifice sizes: 0.5 and 2 mm. The softening prior to extrusion is likened to phenomena measured in a dilatation test, where the coal reaches sufficient fluidity to “slump” and fill the void spaces in the volume. In this case the 25 kg force applied to the coal is equivalent to about 22 bar of pressure and therefore is expected to enhance fluid properties by ensuring greater retention of volatiles. In FIG. 3, it can be observed that this softening behaviour is similar in both cases, but the extrusion occurs faster with the 2 mm orifice, while greater heating (and time) is required to extrude through the smaller 0.5 mm orifice. The measurement of speed is a direct indicator for viscosity of the extruded plastic material. As the plastic phase reaches a critical fluid point it may be extruded through the narrow orifice. Overall, a critical viscosity between 4000-9000 Pa·s is needed to initiate extrusion; while a steady state viscosity between 370-1000 Pa·s appears to be obtained (in FIG. 3) as a constant extrusion speed is reached.

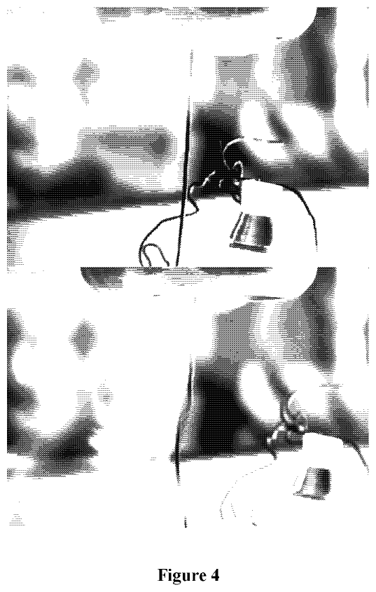

Initial extrusion begins slowly as fluidity is developed inside the extruder body with early extrudates exhibiting only minor amount of volatiles. In these tests, extrusion continues until all material is removed from the heated vessel and this typically occurred prior to reaching 450° C. With development of fluidity, the volatile evolution also appeared to increase, in some cases evolving from the extrudate at lengths apart from the extruder body. FIG. 4 shows early and late periods of extrusion (upper and lower photographs respectively) demonstrating the visible differences in volatile release.

During these extrusion runs, the speed of the extruded product is determined solely by the viscosity of the plastic material in the extruder body. As such, the quality of product was found to vary across each run. In total, the final product was typically either allowed to flow into an aluminium tray or coiled into a bucket. FIG. 5 shows a coiled extruded product, demonstrating some flexibility and handle-ability, though it was observed that this intermediate product was still relatively brittle and in need of further refining to reduce the diameter (to increase flexibility) and thermal annealing (to increase strength) as is required of currently made carbon fibres.

### Effect of Heating Rate on Coal Extrusion

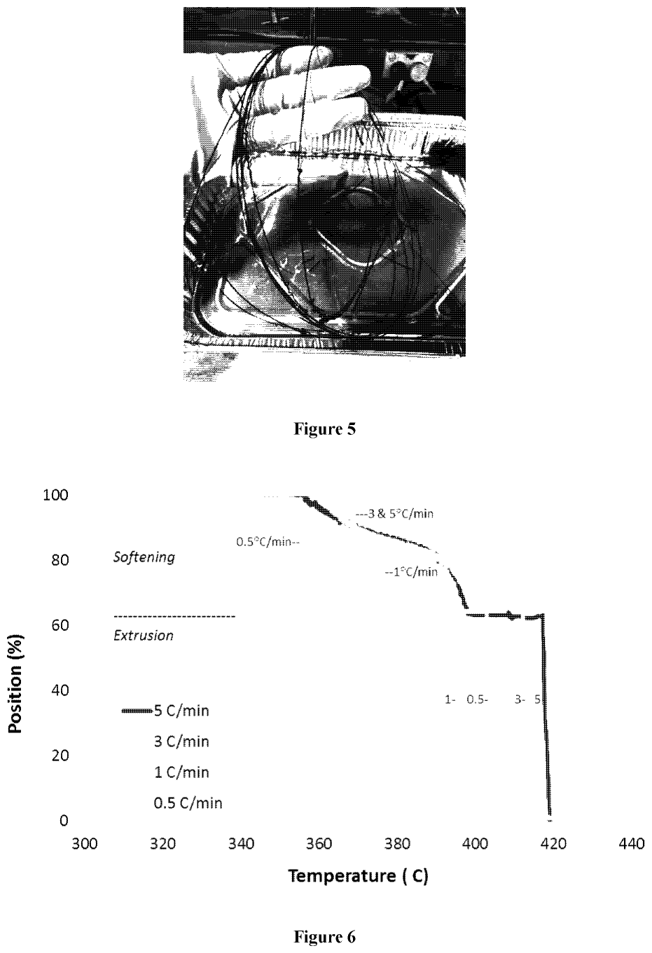

A series of runs were conducted to determine the influence of heating rate during extrusion. FIG. 6 shows the normalised results of this campaign. The softening period was the same for heating rates 3 and 5° C./min, while slower heating rates appear to be shift the softening period to earlier temperatures. In all cases, this softening phenomenon occurs down to about 64% of packing height and hold for a period of time, likely while fluidity is further developed to sufficient viscosity. The lowest extrusion temperature occurs with the 1° C./min at 394° C. followed by the 0.5° C./min at 402° C. then 412 and 417° C. for the 3 and 5° C./min runs, respectively. Clearly the lowest heating rate of 0.5° C./min may in fact be too low for this process indicating the kinetic impacts of fluid development. In all cases, extrusion is finished well before heating to 450° C., essentially extruding all material prior to reaching a resolidification point.

### Coal Extrusion Under Isothermal Conditions and Varied Holding Time

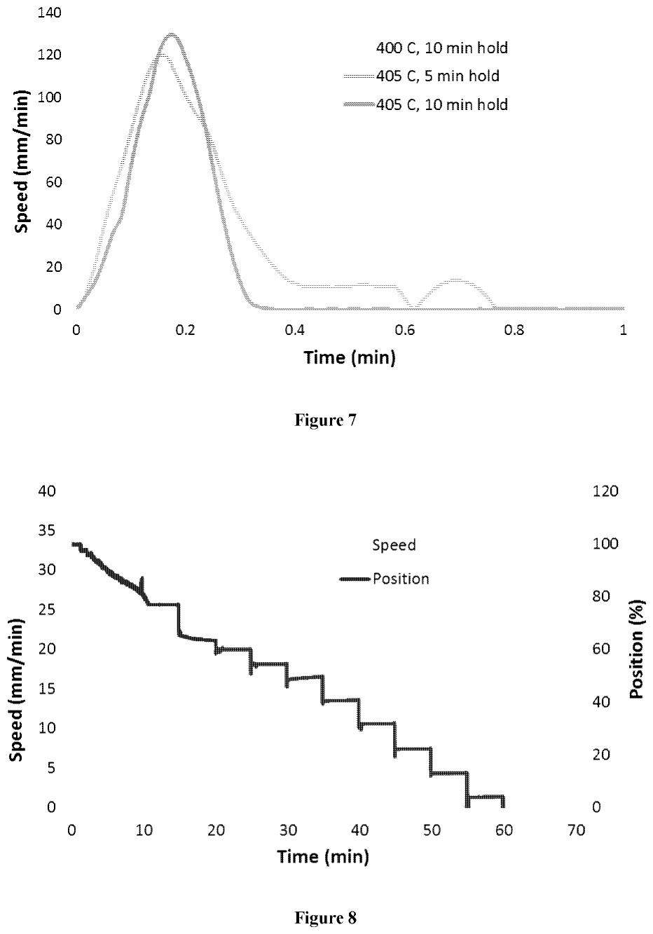

As an alternative to continuous heating, the extrusion system was also operated at constant temperature-holding the extrusion force until a selected 5-10 minute time period before releasing. FIG. 7 shows the impact of time and temperature on extrusion speed. For these experiments a heating rate of 5° C./min was used to heat to the selected temperatures. In all three cases, the actuator reaches a peak speed of about 120 mm/min, equating to viscosity of about 30 Pa·s. This was significantly faster (and more fluid) than measured with the constant heating rate operation and extruded all of the thermoplastic inventory within 1 minute. This demonstrated that providing a small amount of residence time at a temperature early in the thermoplastic development can provide an opportunity to improve fluid conditions for extrusion. However, the subtle differences between these runs, particularly after this peak speed, also suggested that the fluid developed under each of these time-temperature conditions may exhibit differences under continuous extrusion. Images taken of these intermediate fibre products below also show some of these differences.

### Coal Extrusion Under Isothermal Conditions Over Longer Time Periods

A further variation in extruder operation was in a stepwise process at a selected temperature. In this mode of operation, the actuator was allowed to sit idle for a time period (in this case 5 minutes) before applying force and incrementally driving the extrusion forward by 2.5 mm (selected). This variation allowed for speed measurements to be made without extruding the entire plastic inventory in one time increment. This stepwise process is similar to how capillary rheometers are operated for polymers to derive viscosity measurements at constant temperature. For coal, it was expected that the fluid development at any temperature would be kinetically driven and hence eventually reach a re-solidification point. Using this step-wise process, the measurements were expected to provide an understanding of how viscosity changes with time at a selected temperature—and hence how much residence time a coal may have in a continuous system before coking up.

FIG. 8 shows the results for a stepwise operation at 390° C. using 5 minute time intervals and 2.5 mm displacement increments. The lower temperature being selected to allow for fluid development to be monitored over a longer period. It shows an initial softening phase with applied force. The actuator was allowed to move during this softening to 25 mm and then held until a 10 minute time interval was reached, whereby actuator was driven downwards in a stepwise process. The peak speeds obtained at 390° C. are initially about 40 mm/min (lower than actuator maximum) and lower to about 22 mm/min at 35 minutes, followed by a final increase to 35 mm/min near the end of extrusion. This corresponds to an initial viscosity of 100 Pa·s developing towards a viscosity of 160 Pa·s during mid-extrusion. The final rise in extruder piston speed may be due to reduced amount of inventory being pushed (ie friction on the extruder walls) or an indication of differences in plastic material that is close to the piston (where volatiles may be allowed to escape). Importantly, this result demonstrates that fluid development can be maintained at extrudable levels for relatively long periods of time (i.e. 60 minutes) if the selected temperature is relatively low in the thermoplastic region. This has industrial ramifications in terms of allowing for process upsets or a re-charge of inventory.

### Characterisation of the Extruded Fibre Product

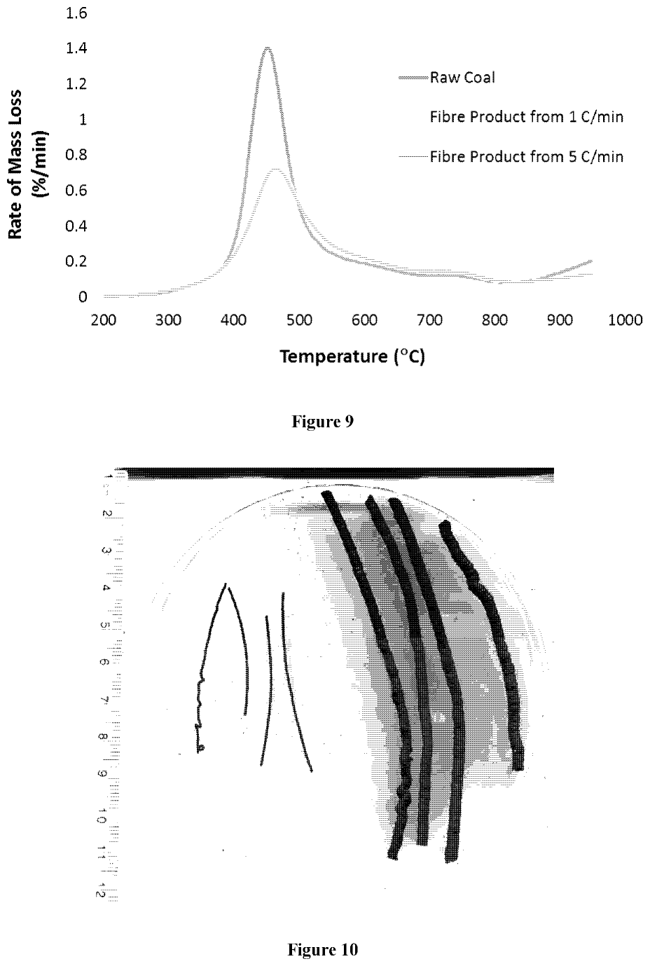

The extruded product through the 0.5 mm orifice plate was selected for further thermogravimetric analysis (TGA) to examine what the impact of extrusion temperature profile would have on the next thermal annealing stage. FIG. 9 shows the rate of volatile loss for products produce at 1 and 5° C./min compared to the raw coal. Overall, the impact of thermal extrusion acts to reduce the rate of peak volatile evolution and shifts this peak point from a temperature of 450° C. to 465° C. (relative to the raw coal). Little difference in thermal profile is exhibited between the two extruded products suggesting that the differences observed in the extrusion profile will have little influence on final high temperature processing.

The proximate analysis derived from the TGA experiments is given in Table 2. Minor differences exist between the raw coal values in Table 1 and 2 and this is likely due to variations in sampling and sample size. The two extruded products have an ash content of 8.3-8.5% and using the ash tracer method, a solid product yield of 72-75% is estimated to produce the intermediate extrudates from the thermal extrusion process.

TABLE 2
Proximate analysis derived from TGA

| Heating | | | | Fixed | Product |
|---|---|---|---|---|---|
| Rate | Moisture | Ash | Volatiles | Carbon | Yield |
| (C./min) | (%) | (%) | (%) | (%) | (%) |
| Raw Coal | 1.6 | 6.3 | 35.4 | 58.3 | |
| Product from | 0.2 | 8.2 | 29.0 | 62.7 | 75.0 |
| 1° C./min | | | | | |
| Product from | 0.1 | 8.5 | 29.2 | 62.3 | 72.1 |
| 5° C./min | | | | | |

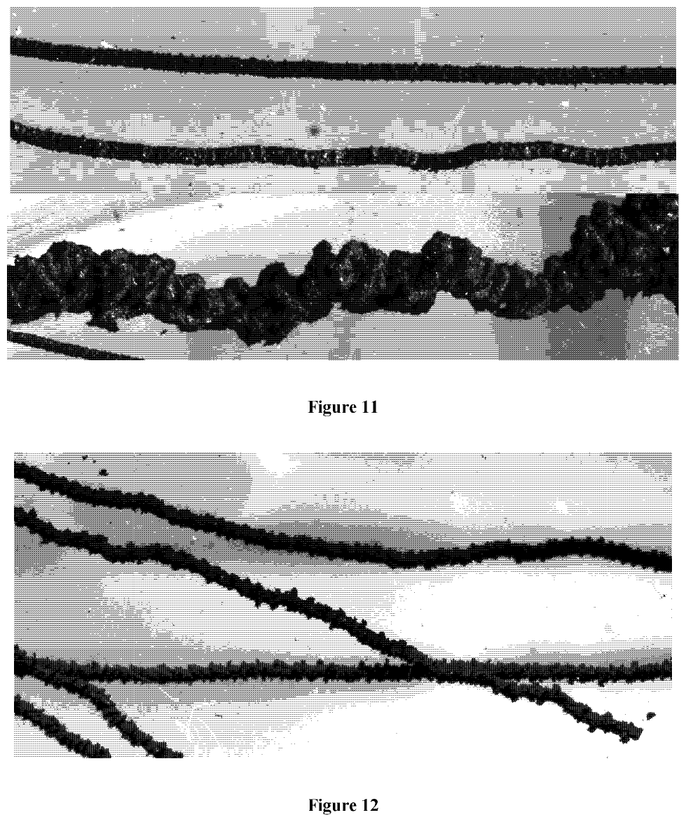

The following section shows typical images of the fibre product from extrusion under different conditions. The images were taken using a desktop scanner in an attempt to capture relatively high resolution images of “bulk fibre character”. FIG. 10 compares the fibres produced using the two orifice plates. The fibres have similar appearance in terms of texture and curvature. For these tests, no efforts were giving to producing a “straight” fibre product, but rather simply allowed to extrude as is. In both cases, the fibres measure a diameter slightly larger than the orifice plate, suggesting a mild expansion is produced from the pressure of the system. FIGS. 11 and 12 show a close-up of fibres produced at 5 and 0.5° C./min, showing examples of smooth and “sharkskin” fibre texture, respectively. The sharkskin effect is well known in polymer technology as a result of instabilities associated with higher shear/stress rate at the die exit. For this work, little effort was given to designing an extrusion nozzle, instead, the orifice plates were designed as a means for controlling fibre size with the ability to be easily removed. Rather than be considered a drawback to the study, this example shows that this apparatus and characterisation method can provide a good indication of conditions that may produce such flow instabilities in the coal's plastic material. FIG. 11 also shows an example of fibre entanglement produced from fibres sticking to the outlet wall and build-up. Taken together with the example of sharkskin, this shows that further application of polymer technology may be required for coal-based extrusion in terms of die design and operation.

### Scanning Electron Microscopy

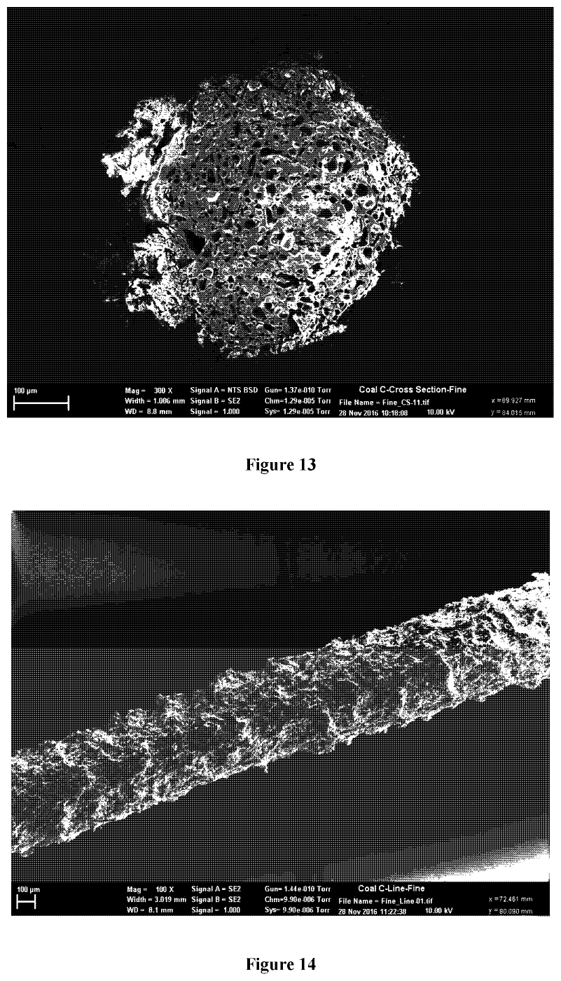

The SEM images in FIGS. 13 and 14 show the novel physical character of the preliminary extrudate produced with the 0.5 mm orifice. This extruded material in FIG. 13 displays high internal porosity (between 3-35 μm in pore size) and an overall thickness of 550-600 μm. It is expected that the porosity can be modified as the extrudate is drawn down to fibre size (10-20 μm) by controlling volatile release. In particular, it may be practicable to use a higher extrusion force and drive the process at higher viscosities to avoid the formation of light gases produced towards the back-end of primary pyrolysis. FIG. 14 shows the surface textural feature of the extruded product. The images taken with the desktop scanner (in FIG. 11) suggested a relatively smooth surface, however, the SEM image in FIG. 14 shows that significant roughness is still apparent at a microscopic level. Overall, this is clear indication that extrusion die design is likely to be critical in achieving smooth surfaced fibres and this is only possible with further analysis of the rheological properties of the coals thermoplastic phase. As a further comment to fibre characteristics, it is not yet clear whether highly porous/rough surfaced fibres are less desirable than more controlled characteristics in terms of carbon fibre manufacture. If the final coal-based carbon fibre is destined to be embedded in resin, these characteristics may prove to be highly amenable to such processes, particularly if the resin is better incorporated into the fibre to make a stronger bond.

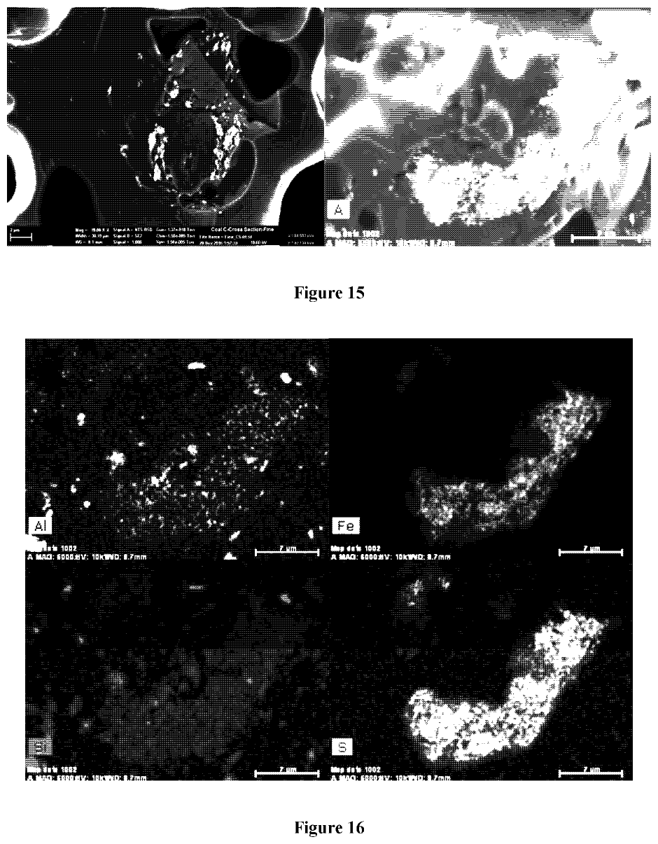

FIG. 15 shows two examples of mineral impurities in the extruded fibre. Recalling that the coal was milled only to a top size of 0.5 mm, these typical mineral impurities appear to be significantly smaller than this, suggesting that the minerals are present within the coal structure, rather than being of a different sediment layer. The minerals in the images measure less than 20 μm in size but also appear to extend to much smaller size. An SEM-EDS analysis was conducted on the right-hand image and this is shown in FIG. 16. This reveals a high concentration of both Fe and S (suggesting the presence of pyrite), while there also appears to be a number of smaller minerals (less than about 1 μm) rich in Al—Si (suggesting the presence of alumina-silicates). These mineral impurity images were included in the study to show that a feed coal considered for fibre production will likely require some preparation to remove such impurities to an acceptable level. Commercial carbon fibres are typically about 7 μm in diameter, so mineral impurities larger than this will need to be removed. It remains uncertain what impact these minerals will have on fibre strength and the degree to which they must be removed. Laboratory scale methods of mineral removal exist to dissolve such minerals in acid, though commercial processes have yet to reach maturity and are likely to have an impact on the coals thermoplastic properties. Alternatively, some success with the re-processing of coal tailings has suggested that re-grinding followed by floatation can produce a suitably low ash product. Overall, the concept of “fibre” grade coal is likely to be a combination of high vitrinite/low mineral matter/high thermoplasticity. However, the degree to which these properties can be concentrated/removed/controlled (respectively) will be determined by fibre strength requirements and processing cost.

A novel thermal extrusion system was developed for assessing the potential to make carbon fibres directly from coal. This work has undertaken to evaluate an Australian coking coal as a potential candidate for making intermediate extruded products that may then be spun down and carbonised.

The system was operated to analyse the coals thermoplastic properties at an extrusion pressure of about 22 bar by changing the heating rate and holding times. Overall, the coal showed an early softening phase which was affected by slower heating rates (0.5-1° C./min). This phase proceeded extrusion which began at a critical viscosity of 4000-9000 Pa·s and reached steady state extrusion between 370-1000 Pa·s depending on orifice size. It was also found that holding the coal at temperature early in the softening process could maintain a relatively low viscosity fluid phase for up to 60 minutes.

Characterisation of the extruded fibre product showed that these intermediate fibres were high in porosity and exhibited a rough surface texture. In some instance, this surface roughness appeared similar to “sharkskin” phenomena observed in polymers during high-shearing. Mineral impurities were observed in the coal suggesting that some degree of preparation would likely be required to obtain “fibre-grade” quality coal.

This study has successfully shown that coking coal can be sufficiently extruded during its thermoplastic phase to make an intermediate product suitable for further fibre processing. This suggests a new low cost pathway for making carbon fibre is possible. This study has also demonstrated a series of characterisation methods for assessing different coals as feed stock.

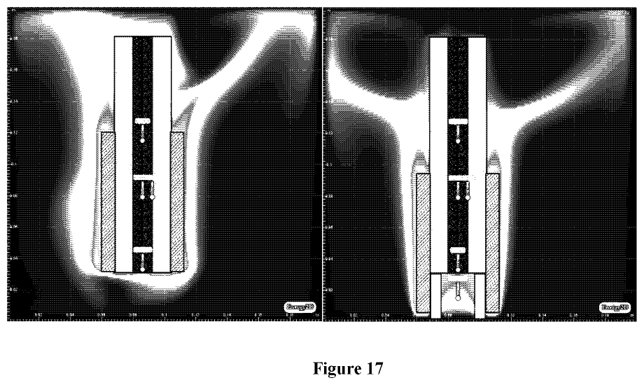

A study was conducted on the effect of adding a sheath surrounding the extruder orifice. Thus convective modelling has shown that the addition of a sheath can serve to trap hot gases around the aperture, thereby restricting their escape from the vicinity of the aperture. This reduces the temperature gradient across heated zone, allowing the sample to be relatively isothermal and provides additional control of the cooling of the extruded fibre by increasing the region of hot gas through which the extruded fibre passes prior to cooling. An image of the convective modelling is shown in FIG. 17, illustrating the effect of the sheath.

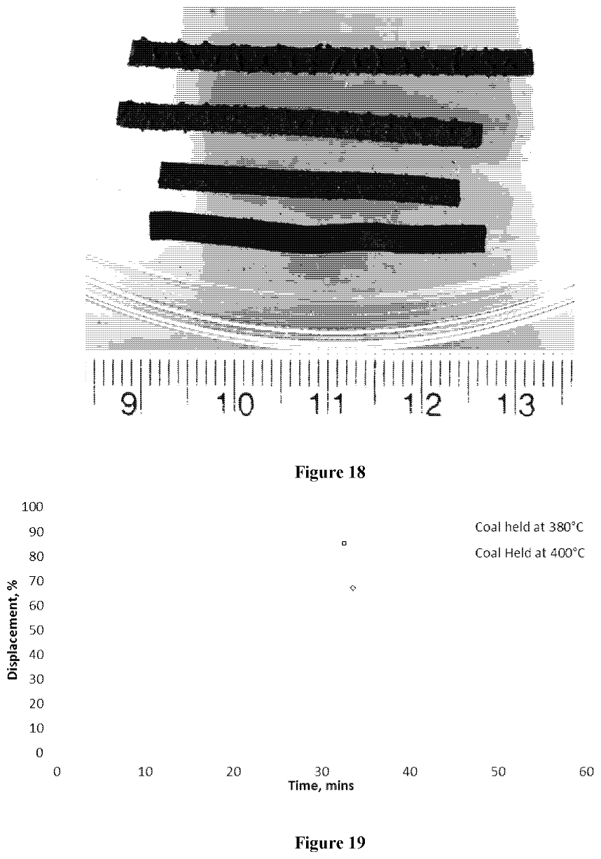

A further study was conducted on the effect of increased extrusion temperature and corresponding reduced viscosity on the morphology of the extruded fibre. Thus FIG. 18 illustrates different morphologies, with higher temperatures shown higher in the figure, with images of coking coal extrusions sampled from the start of extrusion to the end, showing differences in extruded characters as viscosity develops from 628,000 Pa·s at 400° C. to 25,000 Pa·s at 410° C. The fibre can be seen to change from smooth extrusion to rougher texture, known as “sharkskin”. It is thought that, as the coal becomes more fluid (i.e. lower viscosity) with higher temperature, the extrusion speed is increased for a constant applied pressure, leading to increased levels of surface roughness.

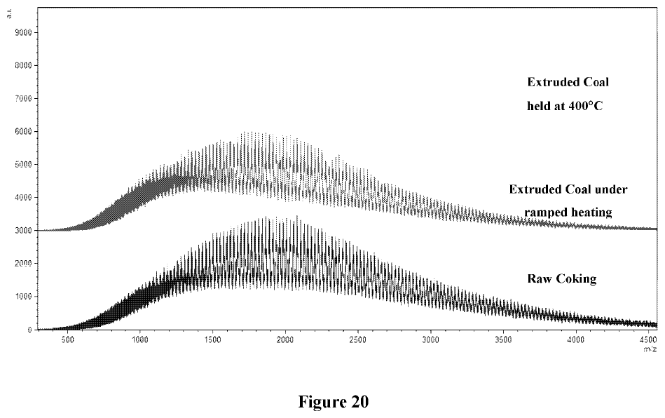

FIG. 19 shows that holding the temperature in the softening phase does not provide conditions for sufficient fluidity to extrude. In other words, temperature plays a crucial role in developing the coal fluid properties. As noted earlier, the softening of coal with temperature is a dynamic phenomenon, i.e. it is time dependent, and therefore coal held at a temperature which is insufficient to fluidise the coal will result in no extrusion even over extended times.

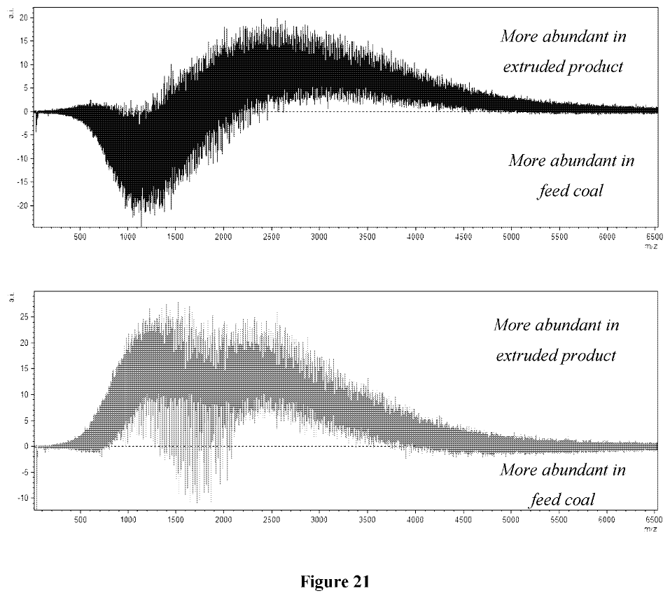

FIGS. 20 and 21 show the results of a molecular weight study of the extruded coal. Thus FIG. 20 shows the molecular weight distributions (measured using LDI-TOF-MS: laser desorption/ionisation time of flight mass spectrometry) of the raw coal prior to extrusion (bottom), coal extruded at a constant temperature of 400° C. (top) and coal extruded under a temperature ramp (centre). The molecular weight differences following extrusion are highlighted in the difference spectra in FIG. 21 for the ramped temperature extruded product (top) and constant temperature extruded product (bottom). It appears from these spectra that the two heating conditions produce different molecular weight distributions in the extruded material. Under ramped temperature conditions, the molecular weight shifts higher, with lower molecular weights more pronounced in the feed material and higher molecular weights more pronounced in the extruded product. The differences are less clear in the isothermally extruded product. It appears that there is some depletion in intermediate molecular materials, but no clear shift of overall molecular weight. This suggests that it is breakdown of intermediate material that initially creates a lower molecular weight product to initiate the softening process; and a higher molecular weight by-product formed in early cross-linking-potentially as part of the same mechanism. It is possible that this indicates that the higher temperatures ultimately achieved during the ramped extrusion serve to crosslink the coal so as to generate higher molecular weights that ultimately form a solid product.

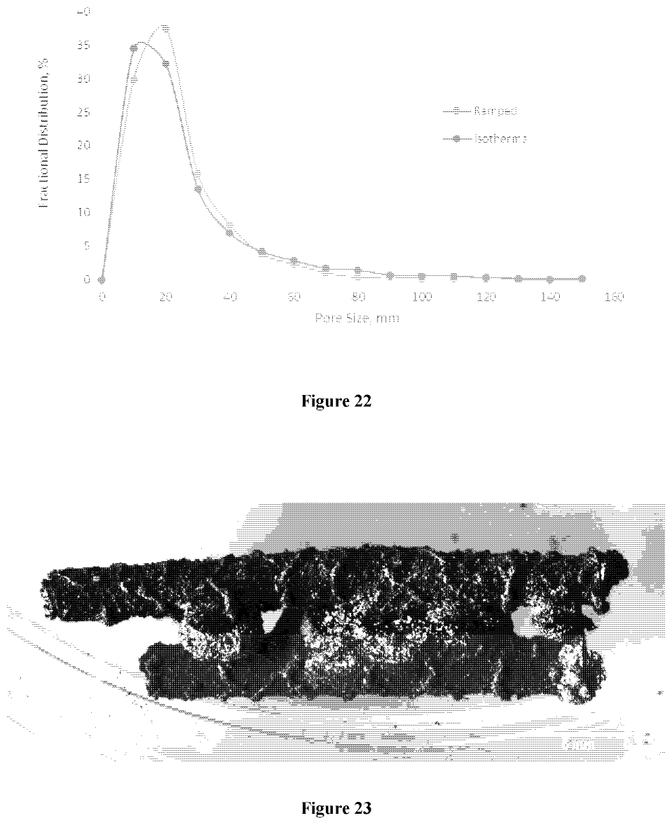

FIG. 22 shows a pore size analysis of extruded fibres, based on image analysis of a scanning electron micrograph of a cross-section of the fibre. Results for fibres extruded both isothermally and using a ramped temperature profile are shown. Results are shown numerically in Table 3, below.

TABLE 3
Results from SEM image analysis

| | Isothermal | Ramped |
|---|---|---|
| Porosity, % | 31.4 | 24.0 |
| Solid Carbon, % | 66.4 | 75.1 |
| Minerals, % | 2.3 | 1.0 |
| Average Pore Size, μm | 21.2 | 19.2 |
| D50 | 13.1 | 14.1 |
| D90 | 46.5 | 37.5 |

A number of differences are noticeable. The porosity is somewhat higher for the isothermal fibres, and this is reflected in the lower percentage of solid carbon. This may be due to the longer time at temperature for these fibres, leading to greater evolution of porogenic gases. However the average pore size is quite similar for the two different temperature profiles, most likely reflecting the same pressure applied to each.

FIG. 23 shows an extruded fibre which has been subjected to subsequent heat treatment at 875° C. It can be seen that the fibre substantially retains its shape even at this high temperature, however there does appear to be evidence of residual thermoplasticity.

1. A process for producing a fibre comprising:
providing particulate coal;
exposing the coal to a temperature sufficient for plasticisation of the coal, so as to form metaplastic coal;
applying sufficient pressure to the metaplastic coal to extrude it through an orifice; and
allowing the extruded coal to solidify in the form of a fibre.

2. The process of claim 1 wherein the particulate coal has a maximum particle diameter of less than about 1 mm.

3. The process of claim 1 wherein the step of providing the particulate coal comprises crushing and/or milling coal.

4. The process of claim 3 wherein the step of providing the particulate coal additionally comprises removing from the crushed and/or milled coal any particles above about 1 mm.

5. The process of claim 1 wherein the particulate coal is at least about 90% vitrinite.

6. The process of claim 5 comprising purifying coal to a vitrinite concentration of at least about 90%.

7. The process of claim 6 wherein said purifying comprises grinding the coal to a particle size of less than about 50 microns and separation of the vitrinite from inertinite.

8. The process of claim 1 wherein the temperature is from about 350 to about 500° C.

9. The process of claim 1 wherein the pressure is from about 2 to about 60 MPa.

10. The process of claim 1 wherein the orifice has a diameter from about 0.5 to about 2 mm.

11. The process claim 1 wherein the metaplastic coal has a viscosity during extrusion of from about 300 to about 100,000 Pa·s.

12. The process of claim 1 wherein the step of allowing the extruded coal to solidify comprises cooling the extruded coal to a temperature at which it solidifies.

13. The process of claim 1 comprising the step of drawing the extruded coal prior to allowing it to solidify.

14. The process of claim 13 wherein the draw ratio is from about 100 to about 1,000,000.

15. The process of claim 1 further comprising annealing the fibre at a temperature of about 800 to about 1500° C.

16. A fibre produced by the process of claim 1.

17. A fibre having a mass ratio of carbon to hydrogen of greater than 12:1 and a porosity of at least about 25%.

18. The fibre of claim 16 having a diameter of about 5 to about 1000 microns.

19. The fibre of claim 16 which is not produced from an acrylonitrile polymer.

20. A polymer composite comprising the fibre of claim 16 as a filler for the polymer composite.
